(19) United States
(12) Patent Application Publication
(10) Pub. No.: US 2018/0121955 A1
(43) Pub. Date: May 3, 2018

(54) Delivery of Content to Reader Device

(71) Applicant: Timothy Peter Munro, Victoria (CA)

(72) Inventor: Timothy Peter Munro, Victoria (CA)

(21) Appl. No.: 13/430,415

(22) Filed: Mar. 26, 2012

(51) Int. Cl. G06Q 30/02

(52) U.S. Cl. CPC G06Q 30/0256

(57) ABSTRACT

A wide variety of content is available for consumption by users on the Internet. Access to this content is facilitated by providing a system to convert at least a portion of this content and distribute the converted content to one or more reader devices. The converted content is configured for presentation on the one or more reader devices. The conversion process may be initiated by a conversion control presented with the content and activated by a user.

### BACKGROUND

The Internet allows users access to a vast array of content, such as articles, blogs, video, audio, and so forth, via Internet browsers. A variety of user devices, such as desktop computers, portable computers, smartphones, tablet computers, and so forth may provide Internet browsers as well as other functionalities. However, these user devices may not provide a sufficiently portable, comfortable, or seamless environment for the consumption of content.

### BRIEF DESCRIPTION OF THE DRAWINGS

FIG. 1 illustrates a system for converting and delivering content from an Internet browser to a reader device in accordance with an embodiment of the disclosure.

FIG. 2 illustrates a user interface of an Internet browser including several forms of content and a conversion control in accordance with an embodiment of the disclosure.

FIG. 3 illustrates a send dialog box in the Internet browser of FIG. 2, which is presented after activating the conversion control in accordance with an embodiment of the disclosure.

FIG. 4 illustrates a block diagram of a content conversion provider in accordance with an embodiment of the disclosure.

FIG. 5 illustrates data which may be used to form converted content for presentation on the reader device in accordance with an embodiment of the disclosure.

FIG. 6 illustrates components of the reader device and presentation of the converted content thereon in accordance with an embodiment of the disclosure.

FIG. 7 illustrates presentation of converted content including supplemental content in accordance with an embodiment of the disclosure.

FIG. 8 illustrates presentation of converted content including second content in accordance with an embodiment of the disclosure.

FIG. 9 illustrates a flow diagram of a process of providing converted content to the reader device in accordance with an embodiment of the disclosure.

FIG. 10 illustrates a flow diagram of a process of providing converted content to the reader device via a wireless wide area networking connection and including supplemental content in return for compensation in accordance with an embodiment of the disclosure.

FIG. 11 illustrates a flow diagram of a process of providing converted content in accordance with an embodiment of the disclosure.

FIG. 12 illustrates a flow diagram of a process of sending data from the reader device to a content provider associated with the converted content in accordance with an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

A variety of content such as articles, blogs, video, audio, and so forth is available to users from the Internet via Internet browsers on user devices. This content may comprise text, graphics, hyperlinks, referents to other content, and so forth. However, these user devices, such as desktop computers, portable computers, smartphones, or tablet computers, may be less than ideal platforms for easy consumption. In comparison, reader devices, such as dedicated electronic book (“e-book”) readers using reflective displays, are relatively comfortable to use, are lightweight, and enjoy long operational times from battery power.

This disclosure describes systems and techniques related to providing converted content for presentation on a reader device. Accessible content is content which exists before conversion, and may be retrieved, stored, or presented by an application such as an Internet browser executing on a user device. Accessible content as used herein may also be known as original content, initial content, or source content. In some implementations, the Internet browser may present a conversion control which, when activated by a user, provides at least a portion of the accessible content as converted content to a reader device. A content conversion provider takes at least a portion of the accessible content and provides converted content in a format configured for presentation on the reader device. The converted content is configured for presentation on the reader device. The configuration may include, but is not limited to, adjusting font, size, or text flow; modifying or removing graphics; and so forth. Once provided to the reader device, the user may present or otherwise consume the converted content on the reader device. The term “accessible content” is used herein to distinguish content which may be accessed or presented by the user device from the converted content configured for presentation on the reader device. Thus, accessible content may include content previously available to users, such as the text of the play “Hamlet”, while a converted content version of these may be configured for presentation on the reader device. In some implementations, the accessible content may have been transcoded or otherwise transferred from another format. For example, the text of “Hamlet” may originate from a plain text file which has been changed to a hyper-text markup language (“HTML”) file.

The converted content may be produced so that navigational elements for moving around a website, advertisements, or decorative elements are omitted. In another implementation, alternate content versions of elements may also be provided in the converted content. For example, an alternate content version of an advertisement suited for display on a black-and-white electrophoretic display may be used in the converted content rather than a full color advertisement as presented in the accessible content.

Supplemental content such as advertisements may be inserted into the converted content. This insertion may generate a bill for services. For example, when a wireless wide-area network (“WWAN”) or other network, which is relatively costly to transfer data, is utilized to transfer converted content to the reader device, supplemental content may be inserted to offset at least in part costs associated with the WWAN data transfer.

The converted content may also incorporate annotations. Annotations may include highlights, underlines, or comments which may be generated by a reader device or an e-Book reading application. In some implementations, annotations may be exchanged between the reader device and a provider of the accessible content, allowing bi-directional exchange of annotation data. For example, annotations made on the reader device may appear in content presented by a content provider.

### Illustrative System

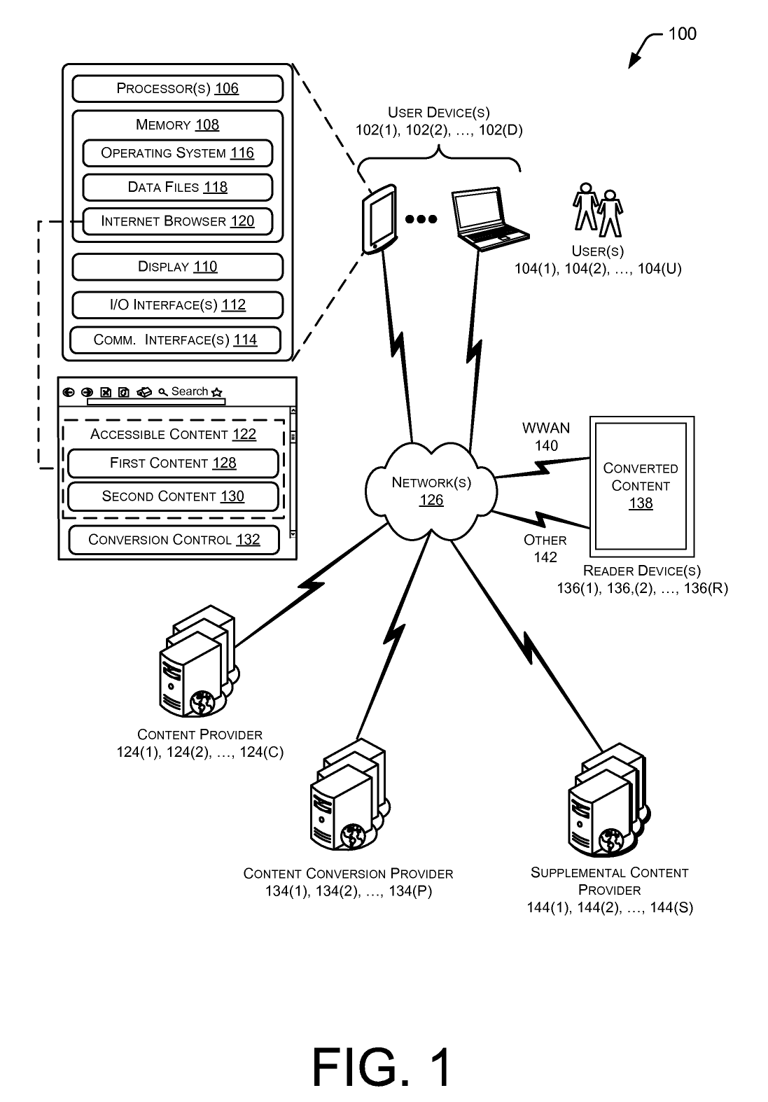

FIG. 1 illustrates a system 100 for converting and delivering content from an Internet browser to a reader device. One or more user devices 102(1), 102(2), . . . 102(D) may be used by one or more users 104(1), 104(2), . . . 104(U). As used herein, letters enclosed by parenthesis such as “(U)” indicate an integer having a value greater than zero. The user devices 102 may include laptops, desktops, tablet computers, televisions, set-top boxes, game consoles, and so forth. The user devices 102 comprise one or more processors 106, one or more memories 108, one or more displays 110, one or more input/output (“I/O”) interfaces 112, and one or more communication interfaces 114.

The processor 106 may comprise one or more cores and is configured to access and execute at least in part instructions stored in the one or more memories 108. The one or more memories 108 comprise one or more computer-readable storage media (“CRSM”). The one or more memories 108 may include, but are not limited to, random access memory (“RAM”), flash RAM, magnetic media, optical media, and so forth. The one or more memories 108 may be volatile in that information is retained while providing power or non-volatile in that information is retained without providing power.

The display 110 is configured to present visual information to the user 104. In some implementations the display 110 may comprise an emissive display configured to emit light to form an image. Emissive displays include, but are not limited to, backlit liquid crystal displays, plasma displays, cathode ray tubes, light-emitting diodes, image projectors, and so forth.

The one or more I/O interfaces 112 may also be provided in the user device 102. These I/O interfaces 112 allow for coupling devices such as keyboards, joysticks, touch sensors, cameras, microphones, speakers, haptic output devices, memory, and so forth to the user device 102.

The one or more communication interfaces 114 provide for the transfer of data between the user device 102 and another device directly, via a network 126, or both. The communication interfaces 114 may include, but are not limited to, personal area networks (“PANs”), wired local area networks (“LANs”), wireless local area networks (“WLANs”), wireless wide-area networks (“WWANs”), and so forth. The communication interfaces 114 may utilize acoustic, radio frequency, optical, or other signals to exchange data between the user device 102 and another device such as an access point, a host computer, a router, a reader device, another user device 102, and the like.

The one or more memories 108 may store instructions for execution by the processor 106 to perform certain actions or functions. These instructions may include an operating system 116 configured to manage hardware resources, such as the I/O interfaces 112, and provide various services to applications executing on the processor 106. The one or more memories 108 may also store data files 118 containing information about the operating system, previously stored content, portions of content, configuration files, and so forth.

An Internet browser application 120 is stored in the one or more memories 108. The Internet browser application 120 retrieves accessible content 122 from one or more content providers 124(1), 124(2), . . . , 124(C) via a network 126 or from the data files 118. The content providers 124 may comprise information aggregators, entertainment providers, news outlets, online merchants, social media, other users 104, and so forth.

The Internet browser application 120 of the user device 102 may be configured to accept input, such as an Internet or web page coded input using a markup language such as Hyper Text Markup Language (“HTML”), and present the associated content to the user 104, such as via the display 110. The network 126 may comprise one or more private networks, public networks such as the Internet, or a combination of both configured to transfer data between two or more devices.

The accessible content 122 may comprise text information such as articles, blogs, graphical elements such as graphs and charts, video, audio, and so forth. In addition to material of primary interest to the user 104, the accessible content 122 may comprise navigational elements, advertisements, decorative elements, newsfeeds, lists of related hyperlinks, referents to other content, and so forth. For ease of discussion in this disclosure and not by way of limitation, the accessible content 122 is described in terms of two categories: first content 128 and second content 130. The first content 128 is that which is deemed of interest to the user 104. For example, a primary text entry of an online news article may be designated as first content 128. In contrast, the second content 130 is that which is deemed to be of secondary or lesser initial interest to the user 104. Continuing the example, the advertisements and navigational elements may be deemed to be second content 130 relative to the first content 128.

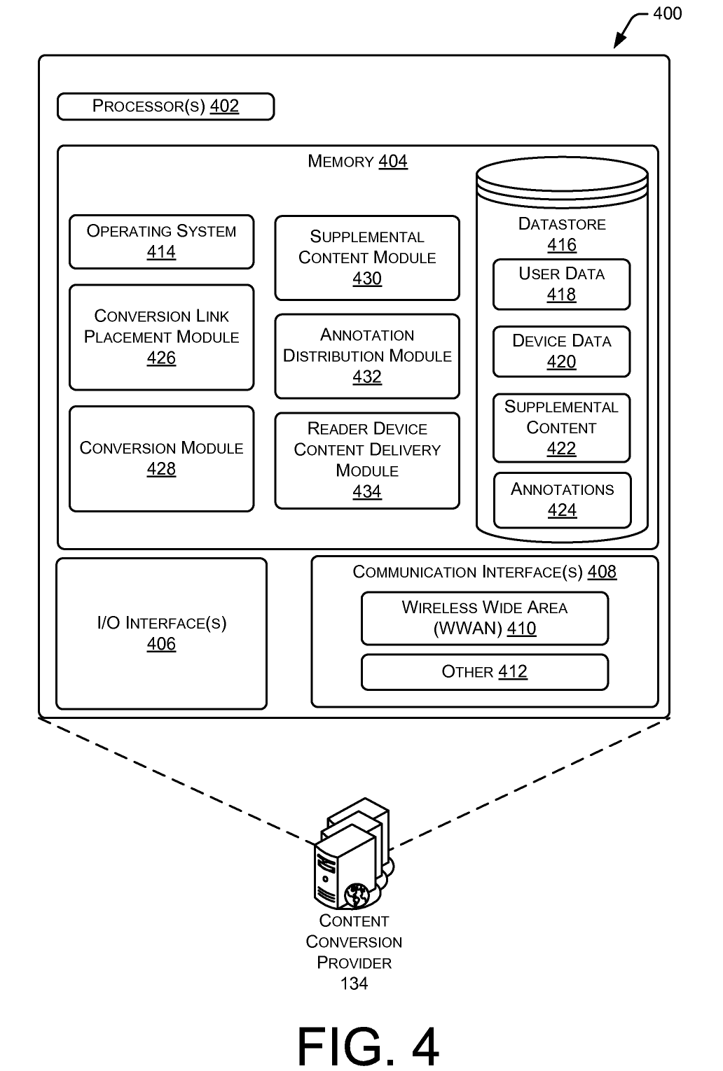

A conversion control 132 may be presented to the user 104, such as in a user interface via the display 110 displaying the accessible content 122. The conversion control 132 is configured such that, when activated, one or more content conversion providers 134(1), 134(2), . . . , 134(P) provide one or more reader devices 136 with converted content 138 via the network 126. The converted content 138 is configured for presentation on the reader device 136 and may be accessible by the reader device 136 using a WWAN connection 140, or other connection 142 such as a WLAN, LAN, and so forth. The content conversion provider 134 is discussed below with regards to FIG. 4.

The conversion control 132 may be configured to be activated by the user 104, by an application or script, or a combination thereof. For example, an accessibility application configured for a user 104 with low vision may be configured to automatically send accessible content 122, which is textual, to the reader device 136 for easier viewing. As a result, upon navigating to the Internet page, the associated converted content 138 may be delivered without intervention of the user 104.

In addition to at least a portion of the accessible content 122, the converted content 138 may include supplemental content. The supplemental content may be provided by one or more supplemental content providers 144(1), 144(2), . . . , 144(S) which may be coupled to the one or more content conversion providers 134 via the network 126. The supplemental content may comprise additional links related to at least a portion of the accessible content 122, information frequently requested by consumers of the converted content 138, advertisements, and so forth. Supplemental content is discussed below in more detail with regard to FIG. 4.

As mentioned above, a differential in cost to transfer data exists between different networks. For example, transfer of data across the WWAN 140 may incur charges to a party such as the content conversion provider 134 while transfer of data using the other 142 networks may not. In some implementations, supplemental content or other additional data may be included with the converted content 138 in return for compensation. This compensation may be used to offset costs associated with delivery of the converted content using the WWAN 140. The compensation may be realized by billing another party for services. The conversion of content is discussed in more detail below with regard to FIG. 4.

The converted content may also include annotations. These annotations include highlights, underlines, or comments , and so forth such as generated by the reader device or an e-Book reading application. Annotations associated with the converted content 138 may be incorporated into the converted content 138 which is accessible by the reader device 136. Annotations are discussed below in more detail with regard to FIG. 4.

While various functions are described above with respect to particular devices, it is understood that these functions may be distributed in many ways across the devices. In one example, the content conversion provider 134 functionality may be provided at least in part by the user device 102. In another example, the content provider 124, the content conversion provider 134, and the supplemental content provider 144 may be combined into a single server or set of servers.

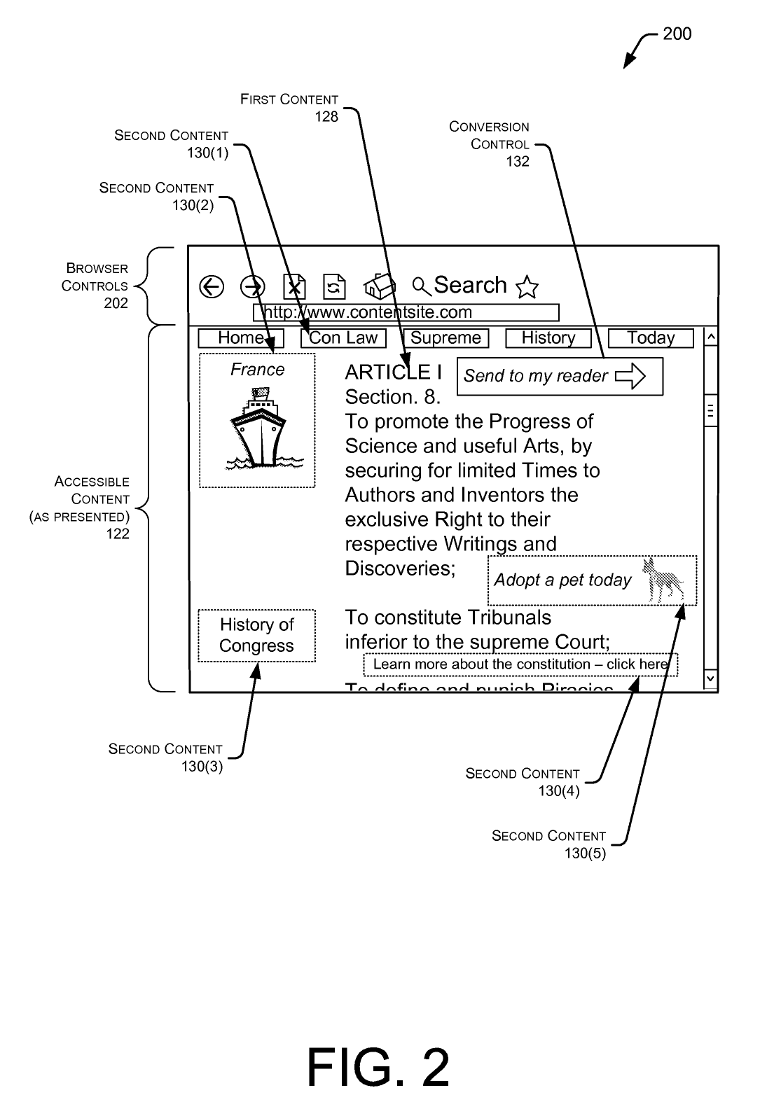

FIG. 2 illustrates a user interface 200 of the Internet browser application 120 as presented on the display 110 of the user device 102. As described above, the Internet browser application 120 presents to the user 104 content such as the accessible content 122 from the one or more content providers 124. The Internet browser application 120 may comprise a stand-alone application, may be incorporated into an operating system, and so forth.

A set of illustrative browser controls 202 are presented by the Internet browser application 120. These browser controls 202 allow for navigation among web pages, searching, and so forth. In some implementations, the browser controls 202 may be hidden or not presented on a display, yet remain accessible. For example, a hotkey, gesture on a touch sensor, voice input, and so forth may be used to access the browser controls 202 which are not presented on the display.

A portion of the user interface 200 shows the accessible content 122 as presented. The accessible content 122 includes the first content 128 as well as several pieces of second content such as navigational elements 130(1), advertisements 130(2), links for additional information on related topics 130(3) and 130(4), and a public service notice 130(5). While one piece of first content 128 is depicted, it is understood that in some implementations multiple pieces of first content 128 may be presented.

The conversion control 132 is accessible to the user 104. The conversion control 132 may comprise a hyperlink, or executable code, a script, an input device, and so forth. The conversion control 132 is shown here as a selectable element embedded within the accessible content 122 as presented. For example, the conversion control 132 may comprise an executable script and associated visible element presented by the Internet browser application 120 on the display 110. However, in other implementations, the conversion control 132 may comprise a browser plug-in, a standalone application, a built-in browser function, a script, and so forth. The conversion control 132 may execute on the processors 106 of the user device 102, on an external processor, or a combination thereof.

In some implementations, the content provider 124, the content conversion provider 134, another entity, or a combination thereof may receive compensation for providing the conversion control 132, or upon activation thereof. For example, the content provider 124 may receive compensation when a user clicks on the conversion control 132 associated with their content.

When activated, such as by a touch, a click, a keyboard entry, and so forth, the conversion control 132 may initiate a process for providing at least a portion of the accessible content 122 to the reader device 136. In one implementation, this process may occur using pre-determined settings and thus occur “quietly” without user interaction or prompting. For example, one or more particular reader devices 136 may be associated with the user 104 such that upon activation the converted content 138 is provided to those one or more particular reader devices 136.

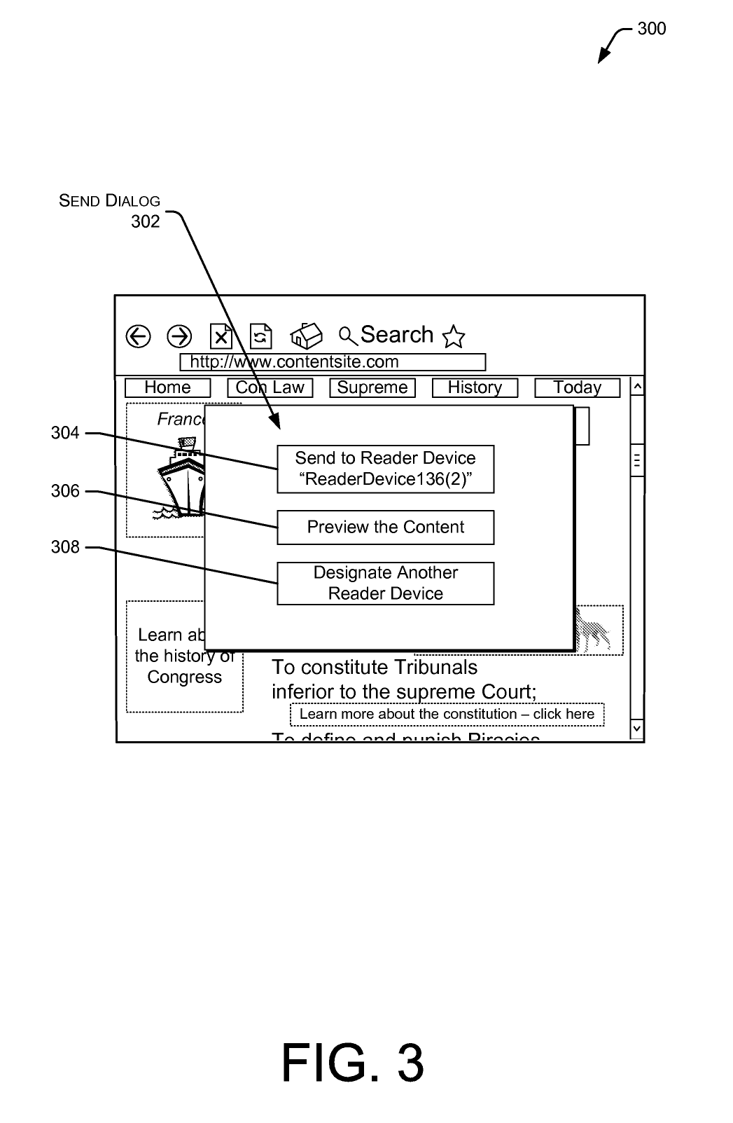

In another implementation, a dialog seeking input to the user may be used, as discussed next with regard to FIG. 3. In yet another implementation, the conversion control 132 may initiate conversion of the accessible content 122 without presenting the accessible content 122 to the user.

FIG. 3 illustrates a user interface 300 in the Internet browser of FIG. 2, which is presented after activating the conversion control 132. The user interface 300 may be generated locally such as on the reader device 136, remotely such as on a server, or using a combination thereof. At least partly in response to the activation of the conversion control 132, a send dialog 302 is presented.

The send dialog 302 may comprise one or more options including send to a pre-determined reader device 304, preview the content 306, and designate another reader device 308. The pre-determined reader device 304 control allows the user 104 to send converted content 138 to a previously designated reader device 136 or a group of reader devices 136. The particular reader device 136 may be determined based at least in part upon a particular login to a particular website, a particular login to a particular user device 102, a type of accessible content 122, a previously stored preference, and so forth. For example, a user may log into an Internet site which generates and stores a cookie stored on the user device 102 having an identifier or serial number associated with a particular reader device 136. As shown here, the pre-determined reader device control 304 will send the converted content 138 to the reader device “ReaderDevice136(2).”

In another implementation, the user 104 may specify a destination address of one or more of the reader device 136 to receive the converted content 138. The destination address may comprise an email address, telephone number, account number, account name, user name, and so forth. For example, the user 104 may activate a “send to email” control and enter “bob@example.com.” This may result in the converted content 138 being sent to the email address specified, a reader device 136 associated with that email address, or a combination thereof

In yet another implementation, an email or other message, such as a short message service (SMS) message, may be sent which includes a link, reference, script, or code which, when executed by the user device 102 presents a preview of the converted content 138, initiates a transfer of at least a portion of the converted content 138 to the user device 102, and so forth.

The preview the content control 306 allows the user 104 to view an approximation or substantially equivalent view of the converted content 138 on the reader device 136. For example, the control 306 may be activated and allow the user 104 to see that the first content 128 correctly includes text and graphics associated with a news article. In some implementations, the preview may also include additional controls to allow for at least a partially manual determination of the first content 128 and the second content 130. For example, controls may allow a user to designate an element as being the second content 130, which in some situations may result in the second content 130 or alternate content being omitted in the converted content 138. Other controls may allow for altering format, preferred delivery method such as via the WWAN 140 or other network 142, or whether to include supplemental content, annotations, and so forth.

The designate another reader device 308 control allows the user 104 to select another reader device 136 for presentation of the content. For example, the user 104 may have a small pocket-sized reader device 136(1) as well as a tabloid size reader device 136(2). The user 104 may thus select which of these reader devices 136 to send the content to. Likewise, a first user 104(1) may send content to the reader device 136(3) associated with a second user 104(2) or group of users.

In some implementations, the conversion control 132 may operate without providing the send dialog 302. In these implementations, the conversion control 132 may determine a destination reader device 136 free from user intervention.

FIG. 4 illustrates a block diagram 400 of the content conversion provider 134. The content conversion provider 134 produces converted content 138 based at least in part on the accessible content 122 for presentation on the reader device 136. The content conversion provider 134 may be deployed in a stand-alone server such as depicted here, distributed across multiple servers, provided as a cloud service, reside as an application on the user device 102 or the reader device 136, and so forth.

The content conversion provider 134 comprises one or more processors 402, one or more memories 404, one or more I/O interfaces 406, and one or more communication interfaces 408. The one or more processors 402 may individually comprise one or more cores and are configured to access and execute at least in part instructions stored in the one or more memories 404. The one or more memories 404 comprise one or more CRSM.

Similar to those described above, the one or more I/O interfaces 406 allow for coupling of devices such as displays, keyboards, storage devices, and so forth to the one or more processors 402 of the content conversion provider 134. Likewise, the one or more communication interfaces 408 may be configured to couple the content conversion provider 134 to one or more networks 126. For example, the one or more communication interfaces 408 may include a WWAN 410 interface, a network interface for other networks 412 such as a LAN connection to an Internet service provider, and so forth.

The one or more memories 404 may store instructions for execution by the one or more processors 402 which perform certain actions or functions. These instructions may include an operating system 414 configured to manage hardware resources, such as the I/O interfaces 406, and provide various services to applications executing on the one or more processors 402. The one or more memories 404 may also store one or more datastores 416 containing information. These datastores may comprise lists, arrays, databases, flat files, and so forth. In some implementations, the datastores 416 may be stored in memory external to the content conversion provider 134 but accessible via a network, such as with a cloud storage service.

The datastore 416 may include user data 418. The user data 418 may comprise information associating users 104 with particular reader devices 136. User preferences, such as color, font size, pagination, whether to include annotations, preferred language, opt-in selection for receiving advertising, and so forth, may also be stored in the user data 418. User access rights may also be maintained in the user data 418. For example, the user 104 may have access allowing conversion of content and access to the converted content 138 for a pre-determined length of time. The user data 418 may be used during production or distribution of the converted content 138.

Device data 420 stored in the datastore 416 may comprise information about the reader devices 136. This information may be general across several devices, such as the display capabilities of a particular model of reader device 136, language support, and so forth, or specific to a particular reader device 136 such as indicating 1.2 GB of storage is available locally on reader device 136(2). The device data 420 may be used during production or distribution of the converted content 138. This device data 420 may be provided by the reader device 136, from the user 104, from a manufacturer or distributor of the reader device 136, and so forth.

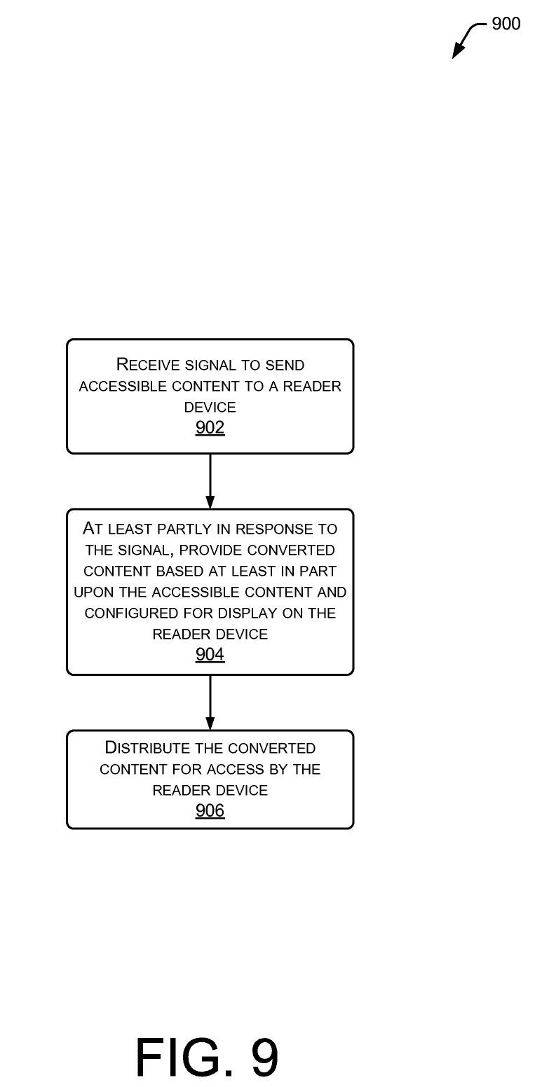

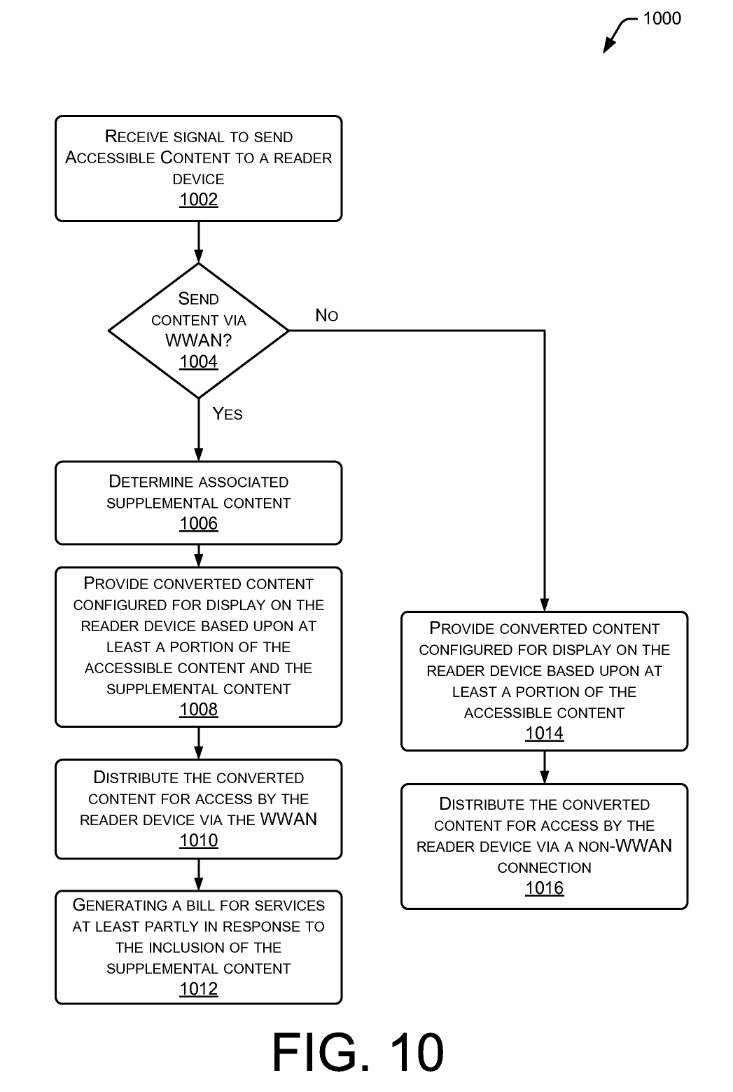

The datastore 416 may also store supplemental content 422. The supplemental content 422 is content which may be associated with at least a portion of the accessible content 122. The supplemental content 422 may comprise static text and graphics, hyperlinks, referents, and so forth and present content including, but is not limited to, advertisements, public notices, public safety information, related information, and so forth. The supplemental content 422 may be incorporated into or provided with the converted content 138. For example, the supplemental content 422 in the form of an advertisement may be presented in the converted content 138 along with the first content 128. In some implementations, including the supplemental content 422 may result in billing for the services of one or more parties, such as an entity operating the content provider 124, the content conversion provider 134, and so forth. The inclusion of the supplemental content 422 from the supplemental content provider 144 is described below in more detail with regard to FIGS. 9-10.

Annotations 424 may be stored in the datastore 416. As mentioned above, in some implementations the datastore 416 or a portion thereof may be external to the content conversion provider 134. For example, the datastore of the annotations 424 may be provided by a third-party such as a purveyor of e-Books. The annotations 424 comprise one or more highlights, underlines, or comments, generated by the reader device or an e-Book reading application. These annotations 424 may be individual annotations by a single user, aggregated annotations generated from a plurality of users, and so forth. In some implementations, annotations 424 may be exchanged between the reader device 136 and the content provider 124 which provides the accessible content 122, allowing bi-directional exchange of information. For example, when the user 104 enters an annotation 424 on the reader device 136, that annotation may be provided to the content provider 124 or another party such as a third-party information aggregator.

Within the one or more memories 404, one or more modules may be stored. As used herein, the term modules designates a functional collection of instructions which may be executed by the one or more processors 402. For convenience in description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

A conversion link placement module 426 is configured to place the conversion control 132 so that it is accessible while the user 104 accesses content. In one implementation, the conversion link placement module 426 may embed a script within an Internet page of the content provider 124. The conversion link placement module 426 may be configured to provide particular conversion options associated with a particular content provider, a particular type of content, and so forth. For example, the conversion link placement module 426 may adjust the conversion control 132 presented on a particular website associated with content provider 124(1) to include particular parameters. These parameters limit presentation or distribution of the converted content 138, such as allowing the conversion control 132 to provide converted content 138 viewable on a particular type of reader device 136 and only for a pre-determined period of time. In another implementation, the conversion link placement module 426 may provide the conversion control 132 with a referent to a previously converted version of the accessible content 122, such as a hyperlink.

The conversion link placement module 426 may be configured to generate the conversion control 132. The conversion control 132 may be configured to designate one or more reader devices 136 to receive the converted content 138 and, when activated, generate the signal to send accessible content presented by the Internet browser to the designated reader device 136.

To aid in this designation of the reader device 136, the conversion control 132 may be configured to access data including, but not limited to, cookies, universal serial bus connection data, previously used delivery options, user login data, or user preferences. This data may be present on the user device 102 such as within the memory 108. For example, the conversion control 132 may be configured to retrieve a login name of the user 104 and a serial number of the user device 102. This combination may be used to designate a default reader device 136 to which the converted content 138 may be sent. In other implementations, the data for the designation may be retrieved from other sources external to the user device 102.

The conversion link placement module 426 may provide other functionality as well. In one implementation, the conversion link placement module 426 may periodically check for the presence of conversion controls 132 within or associated with the accessible content 122, verify functionality of the conversion control 132, acquire usage statistics, and so forth. These usage statistics may be provided to the users 104, the content provider 124, the content conversion provider 134, the supplemental content provider 144, or a combination thereof.

A conversion module 428 produces the converted content 138 for access by the reader device 136. Production of the converted content 138 may include translating, transcoding, reformatting, or otherwise modifying the accessible content 122 or a portion thereof for presentation on the reader device 136. In some implementations, the conversion module 428 may be configured to analyze the accessible content 122 and determine the first content 128 and the second content 130 elements. This analysis may include proximity of words or particular tags relative to one another in the presented content, and accessing tags present within the accessible content 122, by comparison with a pre-determined list, source domain for the accessible content, and so forth. For example, the accessible content 122, which has a source domain of adcontent.xyz.com may be deemed to be the second content 130 while the accessible content 122, with a source of congress.gov, may be deemed to be the first content 128. In other implementations techniques such as semantic analysis, semantic tagging, parsing the accessible content 122, and so forth may be used to determine the first content 128. As described below, in some implementations the first content 128 may be pre-converted. Availability of pre-converted content or an association therewith may be stored at the content conversion provider 134, encoded within a tag in the accessible content 122, and so forth.

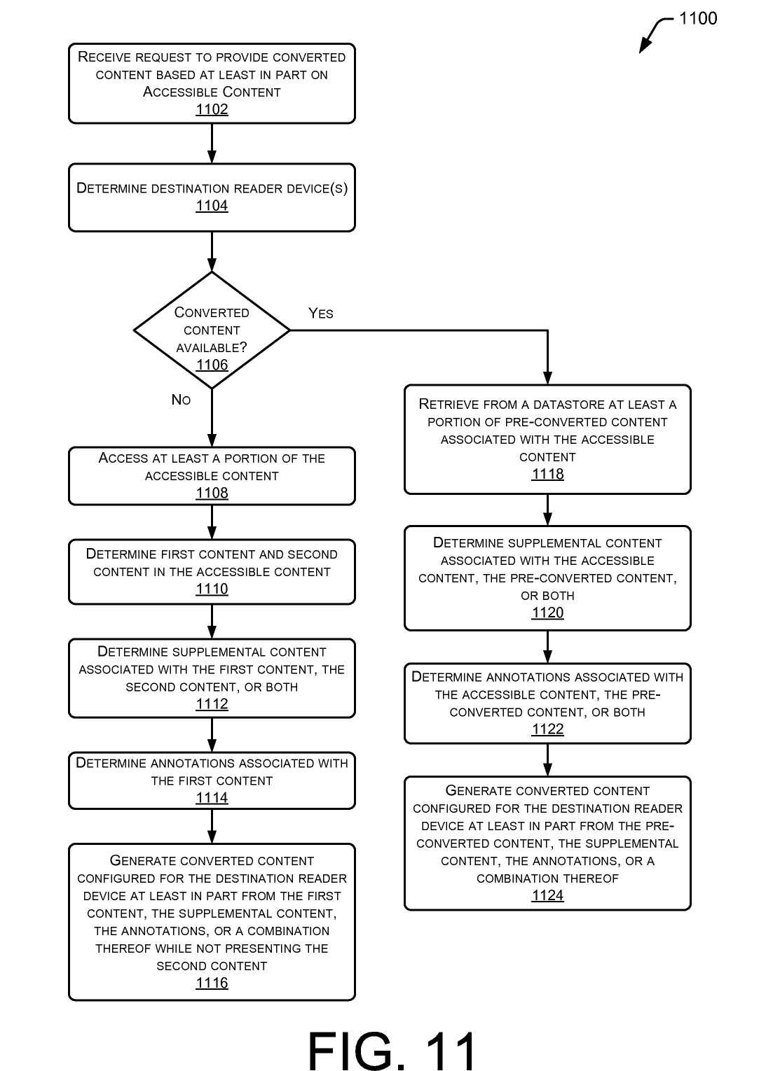

The conversion module 428 may provide conversion upon demand, such as when triggered by activation of the conversion control 132, at a pre-determined time, in response to a pre-determined condition, and so forth. For example, the conversion module 428 may be configured to generate converted content 138 for a popular Internet news site. This previously converted content may be stored, such as in the datastore 416 or with the content provider 124, for future use. Production of converted content 138 is described below in more detail with regard to FIG. 11.

The conversion module 428 may be configured to automatically provide the converted content 138 to the reader device 136. The source of the accessible content 122 to be provided and the frequency of updates may be specified. This may be manually entered, or determined based on interactions with the system. For example, the user 104 may specify to have a particular editorial column available from the content provider 124 provided to the reader device 136 every weekday morning. Interactions include user actions, recommendations, and so forth. For example, interactions such as the user manually activating the conversion control 132 for a particular piece of content seven weekdays in a row may be used to automatically configure the daily conversion for that content.

A supplemental content module 430 is configured to determine the supplemental content 422 associated with at least a portion of the accessible content 122. This association may be pre-determined, dynamic, or a combination thereof. For example, the conversion of the portion of the United States Constitution as depicted in FIG. 2 may be associated with supplemental content 422, such as an advertisement for a course in government from a local community college. Once determined, the conversion module 428 may provide converted content 138 which includes the associated supplemental content 422. In some implementations, at least a portion of the supplemental content 422 may be provided to the reader device 136 in return for compensation. For example, a community college may be billed by an entity, such as the content conversion provider 134 or the content provider 124, for the service of including advertisements about its programs with the converted content 138. This is discussed in more detail below with regard to FIG. 10.

An annotation distribution module 432 is configured to provide annotations associated with at least a portion of the accessible content 122. The annotation distribution module 432 may be configured to access the annotations 424 in the datastore 416 and configure at least a portion of those annotations 424 for presentation by the reader device 136. In some implementations, the annotation distribution module 432 may be configured to provide bi-directional communication between the content provider 124 or another entity or service and the reader device 136. For example, when the user 104 annotates the converted content 138 on the reader device 136, that annotation may be propagated back to the content provider 124. In another information, this bi-directional communication may provide for the reader device 136 to provide content consumption statistics or other information to another party, such as the content provider 124, the content conversion provider 134, and so forth.

A reader device content delivery module 434 is configured to distribute the converted content 138 for access by one or more of the reader devices 136. The reader device content delivery module 434 may use the communication interfaces 408 and send the converted content 138 or a link or other referent thereto via the WWAN 410 or other 412 networks to the reader device 136. In another implementation, the delivery module 434 may provide the converted content 138, link, and so forth to a storage location or service associated with the particular user 104, the particular reader device 136, or both.

The reader device content delivery module 434 may be configured to modify how the accessible content 122 is converted and may vary the converted content 138 which is provided based at least in part upon the mechanism or costs associated with the content delivery. In one implementation, the content conversion provider 134 may be assessed a fee to transfer data, such as the converted content 138, via the WWAN 410 while transfer of data using the other 412 networks may not incur a fee. As a result, the content conversion provider 134 may provide the converted content 138 with supplemental content 422 for compensation. Continuing the above example, the converted content 138 delivered via the other network, such as the WLAN, may omit the supplemental content 422, while the converted content 138 delivered via the relatively costly WWAN may include the supplemental content 422. In another implementation, based on the available bandwidth of the connection used to provide the converted content 138 to the reader device 136, the conversion of the content by the conversion module 428 may be varied. For example, high-resolution photos present in the accessible content 122 may be omitted from the converted content 138 or converted to black-and-white at a lower resolution when the reader device content delivery module 434 provides the converted content over a relatively low bandwidth connection such as the WWAN 410. Thus, the conversion module 428 may interact with one or more of the conversion module 428, the supplemental content module 430, or the annotation distribution module 432 and may vary the converted content 138 as appropriate.

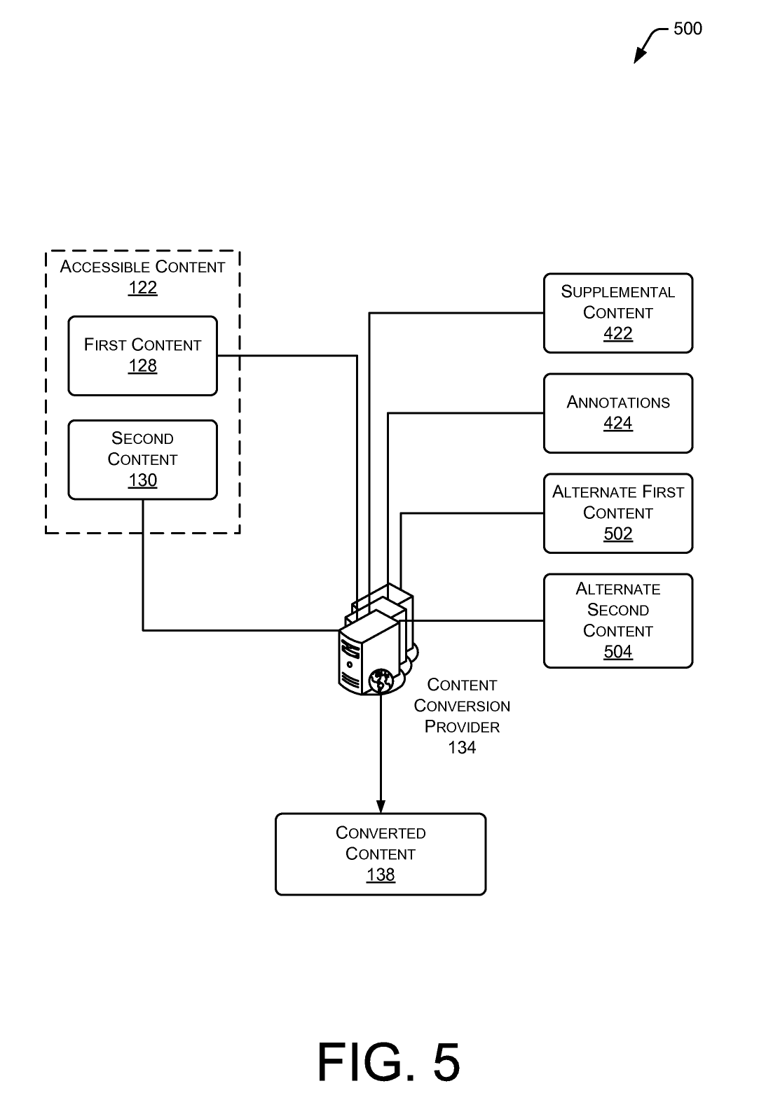

FIG. 5 illustrates a flow of data 500 which may be used to form the converted content 138 for presentation on the reader device 136. As described above, the converted content 138 may comprise at least a portion of the accessible content 122, such as the first content 128, the second content 130, or both. In some implementations, the converted content 138 may also comprise the supplemental content 422, the annotations 424, alternate first content 502, alternate second content 504, or combinations thereof.

The alternate first content 502 is an alternative version or variant of the first content 128. This alternate first content 502 may be stored in a datastore accessible by the content provider 124, the content conversion provider 134, and so forth. Where available, this alternate first content 502 may be used in the production of the converted content 138. The alternate first content 502 may be configured for presentation on the reader device 136. For example, where the first content 128 comprises text of the United States Constitution with an embedded video of the first session of Congress, the alternate first content 502 may comprise the text of the Constitution with a still picture of the first session of Congress instead.

The associations between first content 128 and second content 130 and the corresponding alternate first content 502 and alternate second content 504 may be stored or determined. The associations may be stored as entries in the datastore 416, identifiers encoded within the accessible content 122, and so forth. The association may also be determined based on information available to the system. For example, where no explicit association exists such as an entry in the datastore 416, semantic analysis may associate the first content 128 with the alternate first content 502. In some implementations the user may be presented with a prompt indicating that this is a determined association. For example, the user may see presented on the display 110 “An alternate version has been located which may be suited to your reader device. An excerpt of this is ‘ARTICLE I . . . ’ Would you like to use this version?” Upon acceptance the alternate content may be provided.

The alternate first content 502 may comprise the first content 128 translated from a source language to a destination language. Preferences as to the destination language may be stored in the user data 418 associated with a user, associated with a particular device in the device data 420, and so forth. The alternate first content 502 may be provided in return for compensation in some implementations.

Likewise, the alternate second content 504 may be used to produce the converted content 138 rather than the second content 130. For example, consider when the second content 130(2) comprises an advertisement for a cruise to France which contains simply the text “France” along with a video clip of a cruise vessel. The alternate second content 504 version of this advertisement may omit the video and instead use more descriptive text such as “Cruise to France!”

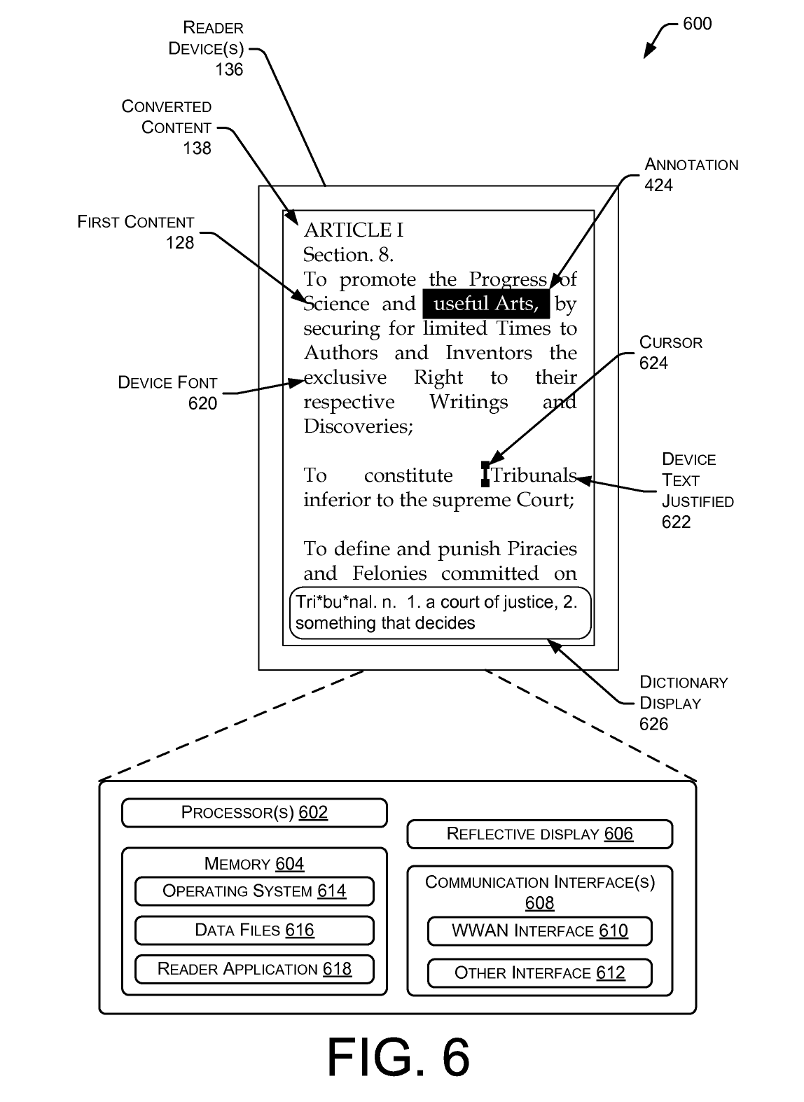

FIG. 6 illustrates components of the reader device and presentation 600 of the converted content. The reader device 136 comprises one or more processors 602, one or more memories 604, one or more reflective displays 606, and one or more communication interfaces 608.

The processor 602 may comprise one or more cores and is configured to access and execute at least in part instructions stored in the one or more memories 604. The one or more memories 604 comprise one or more CRSM. The one or more memories 604 may include, but are not limited to, random access memory (“RAM”), flash RAM, magnetic media, optical media, and so forth. The one or more memories 604 may be volatile in that information is retained while providing power or non-volatile in that information is retained without providing power.

The reflective display 606 is configured to present visual information to the user 104. The reflective display 606 uses incident light to form an image. This incident light may be provided by the sun, general illumination in the room, a reading light, and so forth. Reflective displays include, but are not limited to, electrophoretic displays, interferometric displays, cholesteric displays, and so forth. The reflective display may be configured to present images in monochrome, color, or both. In another implementation, emissive or combination displays using emissive and reflective elements may be used by the reader device 136.

The reflective display 606 may comprise a material or construction which allows for retention of an image for presentation without application of external power, continued refresh, or both. For example, an electrophoretic display may be stable such that when an image is presented power to the display may be discontinued yet the image remains for an extended period of time, such as several hours, days, or years.

The one or more communication interfaces 608 provide for the transfer of data between the reader device 136 and another device either directly or via the network 126. The communication interfaces 608 may include, but are not limited to, interfaces for WWANs 610 as well as other 612 networks such as PANs, LANs, WLANs, and so forth. The communication interfaces 608 may utilize acoustic, radio frequency, optical, or other signals to exchange data between the reader device 136 and another device, such as an access point, a host computer, a router, another reader device 136, and the like.

The reader device 136 may also comprise one or more input/output interfaces, drive electronics, and other devices which are omitted from this figure for clarity. For example, the reader device 136 may comprise keyboards, joysticks, touch sensors, cameras, microphones, speakers, haptic output devices, global positioning system receivers, and so forth.

The one or more memories 604 may store instructions for execution by the processors 602 which perform certain actions or functions. These instructions may include an operating system 614 configured to manage hardware resources, such as the communication interfaces 608, and may provide various services to applications executing on the processor 602. The one or more memories 604 may also store data files 616 containing information about the operating system, previously stored content, portions of content, configuration files, dictionaries, converted content 138, supplemental content 422, annotations 424, and so forth.

A reader application 618 is stored in the one or more memories 604. The reader application 618 provides for the presentation of the converted content 138 on the reader device 136. This presentation may be via a speaker, a haptic output, the reflective display 606, or a combination thereof. The reader application 618 may retrieve the converted content 138 or a portion thereof from the memory 604 or from another memory, such as cloud storage accessible via the network 126.

As shown here, the reader device 136 is presenting the converted content 138 which comprises at least a portion of the first content 128 on the reflective display 606. As shown here by way of illustration and not as a limitation, the converted content 138 as presented by the reader application 618 on the reader device 136 is distinguishable from the accessible content 122 in several ways. For example, the converted content 138 is presented using a device font 620 which differs from the presentation of the accessible content 122 in the Internet browser of FIG. 2. Additionally, device text as displayed is justified 622.

Other differences between the accessible content 122 and the converted content 138 as presented in this illustration include selection as to the content presented. In this illustration, the content conversion provider 134 has omitted the second content 130 from the converted content 138. As a result, the user 104 is viewing the first content 128 and the user interface elements provided by the reader application 618 executing on the one or more processors 602. Additional information may be provided in the converted content 138 as described above, such as the annotation 424 depicted here. In this illustration, the annotation 424 is presented in the form of a user highlight of the words “useful Arts.” As mentioned above, the annotations 424 may include highlights, underlines, comments, and so forth.

A cursor 624 is also presented, which the user may manipulate such as via a touch sensor, a button, a voice input, and so forth. Here the cursor 624 is adjacent to the word “Tribunals.” The reader application 618 has presented a dictionary display 626 for the word “Tribunals” at a bottom of the display comprising a definition of the word. Because the converted content 138 is configured for the reader device 136, additional processing and functionality are available which may assist the user 104 in easily consuming the content.

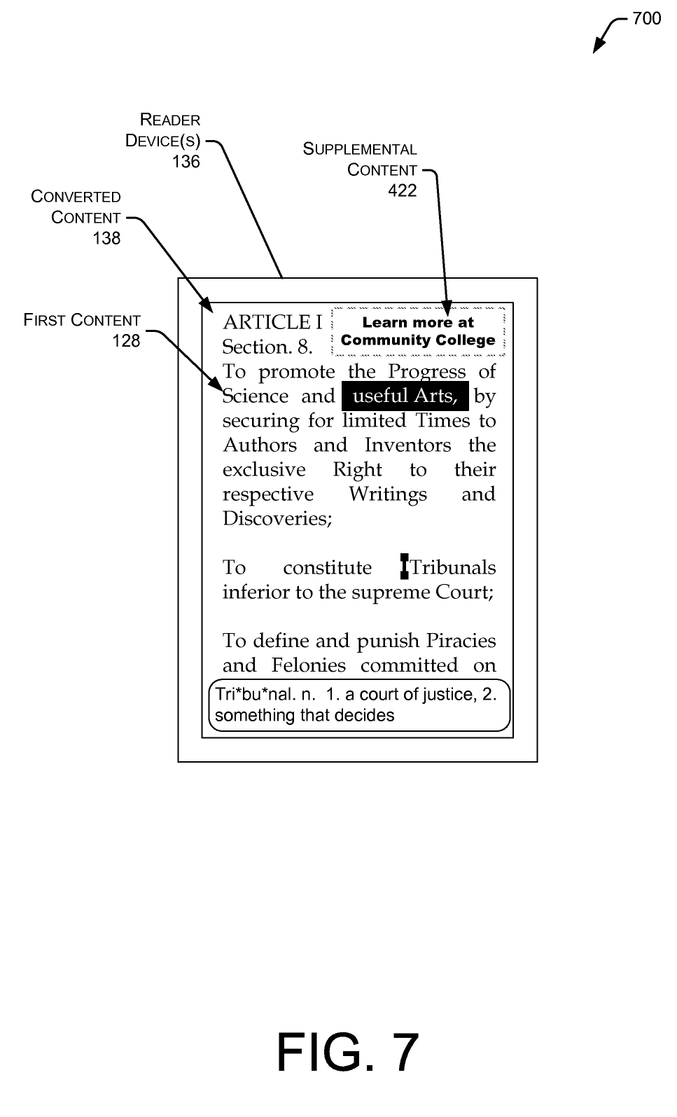

FIG. 7 illustrates another presentation 700 of the converted content 138. In this illustration, the supplemental content 422 is visible. As mentioned above, the content conversion provider 134 may produce converted content 138 which includes supplemental content 422. This supplemental content 422 may not be present in the accessible content 122. For example, as shown here, the supplemental content 422 comprises an advertisement for a local community college which was not present in the accessible content 122 as shown in FIG. 2. As mentioned above, in some implementations, compensation may be given for inclusion of the supplemental content 422 into the converted content 138.

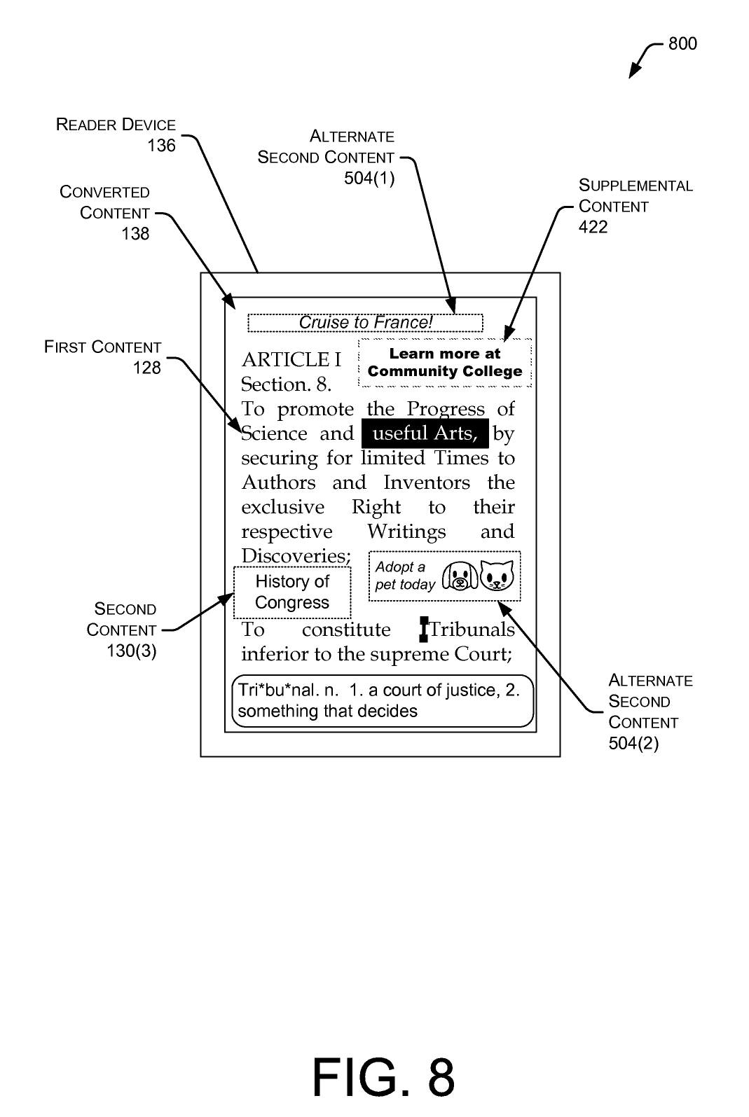

FIG. 8 illustrates yet another presentation 800 of the converted content 138. In this illustration, the converted content 138 comprises at least portions of the first content 128, the supplemental content 422, and the second content 130(3), as well as the alternative second content 504(1) and 504(2).

As described above, the content conversion provider 134 may modify or adjust the accessible content 122 to provide converted content 138 which is suitable for presentation on the reader device 136. As mentioned, where the device provides a black-and-white reflective display, color pictures may not be suitable for presentation. The content conversion provider 134 thus produces converted content 138 which better accommodates constraints associated with the reader device 136 including, but not limited to, screen size, resolution, refresh rate, color display, available memory, and so forth.

Here the second content 130(2) depicting a video of a cruise to France has been replaced in the converted content 138 with the alternate second content 504(1). This alternate second content 504(1) omits the video and uses different, more descriptive text to advertise the cruise. The second content 130(4) containing a color picture and the text “adopt a pet today” likewise may be replaced with an alternate second content 504(2) which uses the same text but has replaced the color picture with a black-and-white line drawing. In contrast, the second content 130(3) required no modification, and was thus included without apparent change to the user 104.

In another implementation, the alternate second content 504 may comprise a more robust version of the second content 130. For example, where the reader device 136 provides a more extensive color gamut compared to the user device 102, the alternate second content 504 may be configured to use this more extensive color gamut in the presentation. The alternate second content 504 may be provided in return for compensation in some implementations.

While the supplemental content 422, second content 130, and the alternate second content 504 are depicted as being inline with the first content 128, in some implementations these elements may be included at different apparent portions during presentation of the converted content 138. For example, the second content 130 may be placed at the beginning of the converted content 138 and displayed adjacent to other second content but separate from the first content 128.

### Illustrative Processes

FIG. 9 illustrates a flow diagram 900 providing converted content to the reader device. In some implementations this process may be carried out by the content conversion provider 134 as described above.

At 902, a signal is received to send accessible content 122 to a reader device 136. For example, this signal may comprise a user or application actuating the conversion control 132 on a user device 102. In another example, a pre-determined trigger, such as an update to the content, time interval, and so forth, may generate the signal. In some implementations, the signal may be received without the user having been presented with the accessible content 122. For example, a change in content of the content provider 124 may result in automatic distribution of the converted content 138 to the reader device 136.

At 904, at least partly in response to the signal, converted content 138 is provided based at least in part upon the accessible content 122. This converted content 138 is configured for display on the reader device 136. The converted content 138 may be provided by accessing previously converted content or generating converted content. Providing this content is discussed in more detail below with regard to FIG. 11.

At 906, the converted content 138 is distributed for access by the reader device. This distribution may include, but is not limited to, transmitting at least a portion of the converted content 138 to the reader device 136, storing the at least a portion of the converted content 138 in a memory accessible to the reader device 136, and so forth. In one implementation, the converted content 138 may be transmitted via electronic mail. Once distributed, the user 104 may then access the converted content 138 via the reader device 136.

As described above, the conversion control 132 may be configured to prompt the user 104 for, or determine automatically, which of one or more reader devices 136 to send the converted content 138 to. For example, the send dialog 302 of FIG. 3 may be presented to the user 104, or the conversion control 132 may be configured to retrieve information designating one or more reader devices 136. This information may be retrieved from the user device 102 such as from cookies, universal serial bus connection data, user login data, and so forth.

The accessible content 122, or a portion thereof, may be accessible only after entry of credentials, payment of a fee, and so forth. For example, a full text of the first content 128 including scholarly amendments may only be presented to the user after payment. In some implementations, the conversion control 132, the content conversion provider 134, the content provider 124, and so forth may be configured such that upon activation of the conversion control 132 an account associated with the reader device 136 or the user 104 is charged a fee. Continuing the example, rather than the user having to create an account to view the full text of the first content 128, by activating the conversion control 132 the fee is assessed without user intervention and the converted content 138 comprising the full text with scholarly additions is delivered. In some implementations the user 104 may be presented with an additional prompt, such as to confirm the transaction.

FIG. 10 illustrates a flow diagram of a process 1000 of providing converted content to the reader device via the WWAN 140 and including supplemental content in return for compensation. In some implementations, this process may be carried out by the content conversion provider 134 as described above.

At 1002, a signal to send at least a portion of accessible content 122 to a reader device 136 is received. For example, the content conversion provider 134 may receive a transmission from the conversion control 132 in the Internet browser application 120.

At 1004 a determination is made as to whether the content conversion provider 134 is to send resulting converted content 138 via the WWAN 140 or the other network 142. As described above, in some implementations the determination may be based at least in part on a cost differential associated with transmitting data via the WWAN 140 or the other network 142. In another implementation, user preferences, available bandwidth, estimated length of time to deliver the converted content 138, network reliability, and so forth may be used to determine which network to use. In some implementations, the user, an administrator, or an automated process may specify that content is to be sent other than by the WWAN 140. For example, a user may specify that the converted content 138 is to be provided via the other network 142 such as a WLAN. Delivery of this converted content 138 may then be deferred until the reader device establishes communication via the other network 142.

When at 1004 the determination is made to send the converted content 138 via the WWAN 140, the process proceeds to 1006. At 1006, the supplemental content 422 associated with at least a portion of the accessible content 122 is determined. At 1008, the converted content 138 is provided which is configured for display on the reader device 136 and based upon at least a portion of the accessible content 122 and the supplemental content 422. As described below with regard to FIG. 11, the converted content 138 may also comprise annotations 424.

At 1010, the converted content 138 is distributed for access by the reader device 136 via the WWAN 140. For example, as described above, at least a portion of the converted content 138 may be transferred to the reader device 136 via the WWAN 140. In another example, at least a portion of the converted content 138 may be transferred to a memory, such as a cloud storage server, which the reader device 136 may then access via the WWAN 140.

At 1012, the content conversion provider 134 or an entity associated therewith generates a bill for services at least partly in response to the inclusion of the supplemental content 422 in the converted content 138. This bill for services may result in one or more of a transfer of credits, electronic funds, service fee offsets, and so forth.

Returning to 1004, when the determination is made to send the converted content 138 via the other network 142, such as a LAN or WLAN, the process proceeds to 1014. At 1014, the converted content 138 is provided which is configured for display on the reader device 136 and based upon at least a portion of the accessible content 122. At 1016, the converted content 138 is distributed for access by the reader device 136 via the other network 142. For example, as described above, at least a portion of the converted content 138 may be transferred to the reader device 136 via the WLAN. In another example, at least a portion of the converted content 138 may be transferred to a memory, such as a cloud storage server, which the reader device 136 may then access via the WWAN 140.

FIG. 11 illustrates a flow diagram 1100 of a process of providing the converted content 138. In some implementations this process may be carried out by the content conversion provider 134 as described above. At 1102, a request is received to provide converted content 138 based at least in part on the accessible content 122. In some implementations this request may comprise parameters such as user access rights, expiration dates, transfer limitations, storage limitations, and so forth.

At 1104, one or more destination reader devices 136 are determined. This determination may be to a specific device such as a particular serial numbered reader device 136, determination of which category or model the destination reader device is a member of, or a group of reader devices 136. As mentioned above, this determination may be used to vary the converted content 138 so that it is configured for the one or more destination reader devices 136. For example, the user 104 may send content to three different models of reader devices 136.

At 1106, a determination is made as to whether converted content 138 is available. Available converted content 138 may be previously converted or generated initially into a format acceptable for use in presentation on the reader device 136. This available converted content may be stored with the user device 102, the content provider 124, the content conversion provider 134, the supplemental content provider 144, another server or data storage service, or a combination thereof.

When at 1106 converted content is not determined to be available, the process proceeds to 1108. At 1108, at least a portion of the accessible content 122 is accessed. For example, the content conversion provider 134 may retrieve a copy of the Internet page presented by the Internet browser application 120 when the user activates the conversion control 132. In another implementation, a locally stored copy of the accessible content 122 may be accessed, such as from the memory 108 of the user device 102.

At 1110, the first content 128 and the second content 130 in the accessible content 122 are determined. Continuing the example, the content conversion provider 134 may analyze the accessible content 122 by looking at one or more indicators to categorize portions of the accessible content 122 into the first content 128 or the second content 130. The indicators include, but are not limited to, proximity of words relative to one another, tags, a pre-determined list of Internet domains, and so forth. For example, the accessible content 122 which has a source domain of adcontent.xyz.com may be deemed to be second content 130, while the accessible content 122 with a source of congress.gov may be deemed to be first content 128.

At 1112, the supplemental content 422 associated with at least a portion of the first content 128, the second content 130, or both is determined. In other implementations, the supplemental content 422 may be associated using content-independent factors including but not limited to user preferences, content access history, and so forth.

At 1114, the annotations 424 associated with at least a portion of the first content 128 are determined. In some implementations, the annotations 424 associated with at least a portion of the supplemental content 422 may be determined in addition to, or instead of, the first content 128.

At 1116, the converted content 138 configured for the destination reader device 136 is generated at least in part from the first content 128, the supplemental content 422, the annotations 424, or a combination thereof while omitting from presentation the second content 130. For example, see the converted content 138 of FIG. 6.

Returning to 1106, when previously converted content 138 is available, in a converted or pre-converted state, the process may proceed to 1118. In some implementations this previously converted content may be stored within a cache, content delivery network, and so forth. At 1118, for example, at least a portion of the pre-converted content associated with the accessible content 122 is retrieved from a datastore. When the pre-converted content of 1118 comprises the supplemental content 422, the annotations 424, or both, the process may proceed to 1124 below or is otherwise complete.

At 1120, the supplemental content 422 associated with at least a portion of the pre-converted content, the accessible content 122, or both, is determined. At 1122, the annotations 424 associated with at least a portion of the pre-converted content, the accessible content 122, or both, are determined.

At 1124, the converted content 138 configured for the destination reader device 136 is generated at least in part from the pre-converted content, the supplemental content 422, the annotations 424, or a combination thereof. In some implementations, the converted content 138 may omit the second content 130 from presentation. For example, see the converted content 138 of FIG. 8.

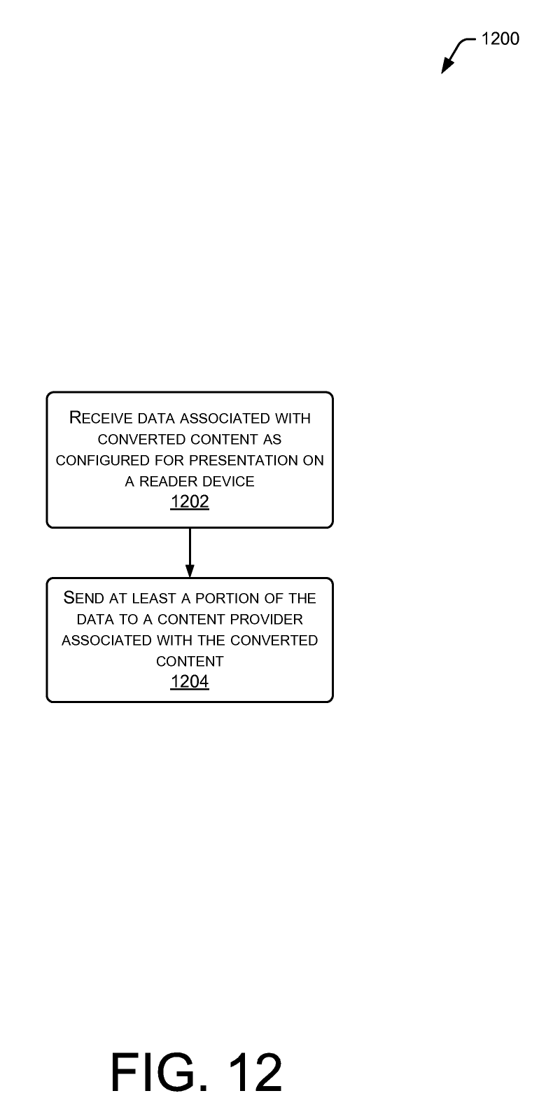

FIG. 12 illustrates a flow diagram of a process 1200 for sending data from the reader device 136 to the content provider 124 associated with the converted content 138. In some implementations, this process may be carried out by the content conversion provider 134, by the reader device 136, or a combination thereof.

At 1202, data associated with the converted content 138 as configured for presentation on the reader device 138 is received. For example, the user 104 may generate an annotation 424 on the reader device 136. In another example, a stream of annotations 424 may be received by the content provider 124 from the content conversion provider 134 or another device in communication with the reader devices(s) 136.

At 1204, at least a portion of the received data is sent to the content provider 124 associated with the converted content 138. Continuing the example, the annotation 424, such as a comment by the user 104 associated with an article from xyz.com is provided back to xyz.com. Those viewing the content at xyz.com would thus see the annotation 424 as made by the user 104. As a result, the users 104 are able to interact with the accessible content 122 as accessed by the user devices 102.

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A system, comprising:
at least one memory storing computer-executable instructions;
at least one network interface device;
at least one processor configured to access the at least one network interface device and the at least one memory and execute the computer-executable instructions to:
provide a selectable content control in association with a presentation of accessible content via a first user device, wherein the accessible content comprises a set of words and an image;
receive an indication of a user selection of the content control designating the image of the accessible content to be first content, and the set of words of the accessible content to be second content;
receive a request from the first user device to send the first content to a second user device, wherein the second user device is different than the first user device and comprises a reflective display, and wherein the request comprises an identification of the first content and the second content;
determine a device characteristic of the second user device;
determine a format for the first content based at least in part on the device characteristic;
at least partly in response to the received request, generate converted content at least in part by removing the second content from the accessible content, wherein the converted content is formatted in the format; and
transmit the converted content to the second user device via a network coupled to the at least one network interface device.

2. The system of claim 1, wherein the reflective display comprises an electrophoretic material and the reflective display is smaller than a display of the first user device.

3. The system of claim 1, further comprising computer-executable instructions to:
generate a conversion control;
provide the conversion control in association with the presentation of the accessible content, wherein the conversion control is configured to:
designate the second user device for receipt of the first content; and
generate the request to send the first content to the second network user device.

4. The system of claim 1, wherein the at least one processor is further configured to execute the computer-executable instructions to:
determine supplemental content associated with the second content, wherein the supplemental content comprises a selectable hyperlink, and wherein the converted content comprises the supplemental content;
determine annotations associated with the first content; and
generate the converted content further at least in part from the first content, the supplemental content, and the annotations.

5. (canceled)

6. The system of claim 1, wherein the at least one processor is configured to generate pre-converted content by removing the second content from the accessible content, and wherein the at least one processor is further configured to execute the computer-executable instructions to:
determine supplemental content associated with at least one of the accessible content or the pre-converted content;
determine annotations associated with at least one of the accessible content or the pre-converted content, wherein the annotations comprise annotations to the first content received at the first user device; and
generate the converted content further at least in part from the pre-converted content and from one or more of the supplemental content or the annotations.

7. The system of claim 1, wherein the converted content is transmitted to an electronic mail address associated with the second user device.

8. The system of claim 1, wherein the network comprises a wireless wide-area network (WWAN).

9. A computer-implemented method, comprising:
receiving, by a content delivery system comprising one or more computer processors, a request to send first content of accessible content from a first user device to a second user device, wherein user selection of a selectable content control provided in association with the presentation of the accessible content causes a first portion of the accessible content to be designated as first content, and a second portion of the accessible content to be designated as second content, and wherein the request comprises an identification of the first content and the second content;
determining a first annotation associated with the first portion, wherein the first annotation was received at the first user device;
removing the second portion from the accessible content and adding the first annotation to the accessible content to generate converted content;
determining a device characteristic of the second user device;
determining a format for the first content based at least in part on the device characteristic; and
providing, by the content delivery system and responsive at least in part to receiving the request, the converted content formatted in the format.

10. The computer-implemented method of claim 9, wherein the second user device is a reader device comprising a reflective display that is smaller than a display of the first user device.

11. The computer-implemented method of claim 9, further comprising receiving data generated by the second user device and sending at least a portion of the data to a content provider of the accessible content.

12. (canceled)

13. The computer-implemented method of claim 9, wherein the first annotation comprises highlights of at least a portion of the first content.

14. The computer-implemented method of claim 9, the converted content further comprising supplemental content determined to be associated with the first content.

15. The computer-implemented method of claim 14, wherein the supplemental content comprises one or more advertisements.

16. The computer-implemented method of claim 14, further comprising generating a bill for services at least partly in response to the inclusion of the supplemental content in the converted content.

17. One or more computer-readable media storing computer-executable instructions that, responsive to execution by at least one processor, configure the at least one processor to perform operations comprising:
receiving, from a first user device with a first display size, a first user selection indicating a first designation of a first portion of accessible content to be first content;
receiving, from the first user device, a second user selection indicating a second designation of a second portion of accessible content to be second content;
receiving, from the first user device, a request to send the first content to a reader device with a second display size that is smaller than the first display size;
generating converted content responsive to receiving the request, wherein the converted content is generated at least in part by removing the second content from the accessible content;
determining a format for the converted content based at least in part on the reader device;
reformatting the converted content to correspond to the format; and
distributing at least a portion of the converted content to the reader device.

18. The computer-readable media of claim 17, the converted content further comprising supplemental content.

19. The computer-readable media of claim 17, the converted content further comprising annotations associated with the first content, wherein the annotations were received at the first user device and are sent to the second user device with the converted content.

20. The computer-readable media of claim 17, the operations further comprising providing bi-directional communication between a provider of the accessible content and the reader device.

21. (canceled)

22. The computer-readable media of claim 17, wherein the request to send the first content available to the reader device is generated at least part in response to activation of a conversion control provided in association with the presentation of the accessible content.

23. The computer-readable media of claim 17, wherein the first content comprises content deemed of interest to the user and the second content comprises one or more navigational elements, advertisements, or decorative elements.

24. (canceled)

25. The computer-readable media of claim 23, the converted content comprising alternate second content in place of the second content, wherein the second content is an advertisement and the alternate second content is a dictionary definition.

26. The system of claim 3, wherein the second content comprises a first content portion, and wherein activation of the conversion control causes a second content portion of the second content to be determined.

27. The system of claim 3, wherein a content conversion provider associated with the system receives compensation responsive to activation of the conversion control.
